(19) United States
(12) Patent Application Publication
(10) Pub. No.: US 2026/0101405 A1
(43) Pub. Date: Apr. 9, 2026

(54) METHODS AND APPARATUSES FOR A LOWER LAYER-BASED MOBILITY CASE

(71) Applicant: Lenovo (Beijing) Limited, Beijing (CN)

(72) Inventors: Lianhai Wu, Beijing (CN); Congchi Zhang, Shanghai (CN); Mingzeng Dai, Shanghai (CN); Shuigen Yang, Shanghai (CN); Le Yan, Shanghai (CN)

(73) Assignee: Lenovo (Beijing) Limited, Beijing (CN)

(21) Appl. No.: 19/112,760

(22) PCT Filed: Oct. 11, 2022
(86) PCT No.: PCT/CN2022/124677

§ 371 Date: Mar. 18, 2025

(51) Int. Cl. H04W 76/20; H04W 36/08; H04W 56/00; H04W 74/0833

(52) U.S. Cl. CPC H04W 76/20; H04W 36/08; H04W 56/0045; H04W 74/0833

(57) ABSTRACT

Embodiments of the present application relate to methods and apparatuses for an uplink (UL) synchronization failure and compliance check in a lower layer-based mobility case under a 3rd Generation Partnership Project (3GPP) 5G system or the like. According to an embodiment of the present application, a user equipment (UE) includes a transceiver and a processor coupled to the transceiver, and the processor is configured to receive a radio resource control (RRC) reconfiguration message via the transceiver, wherein the RRC reconfiguration message includes first configuration information regarding one or more candidate cells; after receiving the RRC reconfiguration message, get one or more timing advance (TA) values related to the one or more candidate cells by performing one or more random access (RA) procedures or by transmitting one or more reference signals to the one or more candidate cells; and switch from a source cell to a first candidate cell within the one or more candidate cells, upon receiving a first indication associated with the first candidate cell from the source cell.

### TECHNICAL FIELD

Embodiments of the present application generally relate to wireless communication technology, especially to methods and apparatuses for a lower layer-based mobility case.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Currently, details regarding an uplink (UL) synchronization failure and compliance check in a lower layer-based mobility case have not been discussed in 3GPP 5G technology yet.

### SUMMARY

Some embodiments of the present application provide a user equipment (UE). The UE includes a transceiver and a processor coupled to the transceiver; and the processor is configured to receive a radio resource control (RRC) reconfiguration message via the transceiver, wherein the RRC reconfiguration message includes first configuration information regarding one or more candidate cells; after receiving the RRC reconfiguration message, get one or more timing advance (TA) values related to the one or more candidate cells by performing one or more random access (RA) procedures or by transmitting one or more reference signals to the one or more candidate cells; and switch from a source cell to a first candidate cell within the one or more candidate cells, upon receiving a first indication associated with the first candidate cell from the source cell.

In some embodiments, the RRC reconfiguration message includes at least one of: a value of a first timer for RA for getting TA; or a maximum total number of preamble transmissions.

In some embodiments, after receiving the RRC reconfiguration message including the value of the first timer, the processor of the UE is configured to: start the first timer in response to initiating a first RA procedure for getting TA within the one or more RA procedures, wherein the first timer is associated with the first RA procedure.

In some embodiments, the processor of the UE is configured to: stop the first timer, in response to successfully getting a TA value related to a candidate cell within the one or more candidate cells by performing the first RA procedure to the candidate cell; or consider the first RA procedure as failed, in response to expiry of the first timer.

In some embodiments, after receiving the RRC reconfiguration message including the maximum total number of preamble transmissions, the processor of the UE is configured to: consider that a second RA procedure for getting TA within the one or more RA procedures is failed in response to reaching the maximum total number of preamble transmissions during the second RA procedure, wherein the maximum total number of preamble transmissions is associated with the second RA procedure.

In some embodiments, in response to failing to get the one or more TA values by performing the one or more RA procedures, the processor of the UE is configured to perform one of: transmitting a first message via the transceiver to the source cell; suspending the first configuration information regarding the one or more candidate cells; and re-initiating the one or more RA procedures to the one or more candidate cells after a first time period.

In some embodiments, the first message includes at least one of: a second indication for indicating that the UE fails to get the one or more TA values related to the one or more candidate cells; or a third indication for indicating that the one or more RA procedures are for getting the one or more TA values.

In some embodiments, the first indication is included in downlink control information (DCI) or a medium access control (MAC) control element (CE).

In some embodiments, in response to the first candidate cell being a primary secondary cell group cell (PSCell), the first indication is received by the UE from at least one of a secondary node (SN) or a master node (MN).

In some embodiments, the processor of the UE is configured to start a handover timer upon an RRC layer of the UE receiving the first indication from a lower layer of the UE.

In some embodiments, the processor of the UE is configured to: determine whether a first TA value related to the first candidate cell is available or not, upon receiving the first indication; in response to determining that the first TA value is unavailable, perform one of: prohibiting initiating a third RA procedure to the first candidate cell for getting TA upon determining that the first TA value is unavailable; declaring a RA failure; determining whether elapsed time since the first TA value is considered as unavailable is less than or equal to a second time period, and prohibiting initiating the third RA procedure in response to determining that the elapsed time is less than or equal to the second time period; and initiating the third RA procedure upon determining that the first TA value is unavailable.

In some embodiments, the processor of the UE is configured to transmit failure related information to the first candidate cell in response to successfully getting the first TA value by performing the third RA procedure, and wherein the failure related information indicates that the first TA value is unavailable before initiating the third RA procedure.

In some embodiments, the processor of the UE is configured to perform a compliance check operation: upon receiving the RRC reconfiguration message; after receiving the RRC reconfiguration message and before initiating the one or more RA procedures; after receiving the RRC reconfiguration message and before the UE being triggered to perform the one or more RA procedures; upon initiating the one or more RA procedures; or upon the UE being triggered to perform the one or more RA procedures.

In some embodiments, in response to successful completion of the compliance check operation, the processor of the UE is configured to perform the one or more RA procedures.

In some embodiments, in response to successful completion of the compliance check operation and upon receiving the first indication, the processor of the UE is configured to perform at least one of the following: transmitting the first indication by a lower layer of the UE to an RRC layer of the UE; or applying second configuration information regarding the first candidate cell within the first configuration information by the RRC layer of the UE.

In some embodiments, in response to occurrence of a failure of the compliance check operation, the processor of the UE is configured to transmit a second message via the transceiver to the source cell, and wherein the second message includes at least one of: an identifier (ID) of a second candidate cell within the one or more candidate cells, wherein the second candidate cell is associated with the failure of the compliance check operation; an index for the RRC reconfiguration message for the second candidate cell; or a fourth indication for indicating the failure of the compliance check operation.

In some embodiments, the second message is at least one of: a master cell group (MCG) failure information message; a secondary cell group (SCG) failure information message; or a UE assistance information message.

In some embodiments, the one or more reference signals include at least one of: a preamble; or a sounding reference signal (SRS).

In some embodiments, the processor of the UE is configured to: receive third configuration information regarding the one or more reference signals generated by the first candidate cell via the transceiver; and transmit the one or more reference signals via the transceiver to the first candidate cell based on the third configuration information.

In some embodiments, the third configuration information includes a configuration for a first time-frequency domain resource associated with a SRS, and wherein, to transmit the one or more reference signals, the processor of the UE is configured to transmit the SRS via the transceiver to the first candidate cell on the first time-frequency domain resource.

In some embodiments, the third configuration information includes a configuration for a second time-frequency domain resource associated with a preamble, and wherein, to transmit the one or more reference signals, the processor of the UE is configured to transmit the preamble via the transceiver to the first candidate cell on the second time-frequency domain resource.

In some embodiments, to transmit the one or more reference signals, the processor of the UE is configured to transmit the preamble to the first candidate cell during a time gap.

In some embodiments, the processor of the UE is configured to prohibit expecting to monitor a response after transmitting the preamble.

In some embodiments, the processor of the UE is configured to receive a third message via the transceiver from the source cell, and wherein the third message includes at least one of: at least one TA value related to at least one candidate cell within the one or more candidate cells; or at least one identifier (ID) of the at least one candidate cell.

In some embodiments, the third message is at least one of: downlink control information (DCI); a medium access control (MAC) control element (CE); or an RRC message.

Some embodiments of the present application provide a centralized unit (CU). The CU includes a transceiver and a processor coupled to the transceiver; and the processor is configured to transmit information via the transceiver to a user equipment (UE), and wherein the information includes at least one of: configuration information regarding one or more candidate cells; at least one timing advance (TA) value related to at least one candidate cell within the one or more candidate cells; or at least one identifier (ID) of the at least one candidate cell.

In some embodiments, the information is included in at least one of: downlink control information (DCI); a medium access control (MAC) control element (CE); or an RRC message.

In some embodiments, the processor of the CU is configured to receive, via the transceiver from a target distributed unit (DU) managed by the CU, at least one of: the at least one TA value related to the at least one candidate cell within the one or more candidate cells; or the at least one ID of the at least one candidate cell.

In some embodiments, the processor of the CU is configured to transmit a radio resource control (RRC) message via the transceiver to the UE, and wherein the RRC message includes a first indication associated with a cell change to a first candidate cell within the one or more candidate cells.

In some embodiments, the processor of the CU is configured to transmit an indication via the transceiver to a source DU managed by the CU, and wherein the indication indicates the source DU to transmit a first indication associated with a cell change to a first candidate cell within the one or more candidate cells to the UE.

In some embodiments, in response to the first candidate cell being a primary secondary cell group cell (PSCell), the CU is associated with a secondary node (SN) or a master node (MN).

In some embodiments, the processor of the CU is configured to receive a first message via the transceiver from the UE, and wherein the first message includes at least one of: a second indication for indicating that the UE fails to get one or more TA values related to the one or more candidate cells; or a third indication for indicating that one or more random access (RA) procedures performed by the UE are for getting the one or more TA values.

In some embodiments, the processor of the CU is configured to receive a second message via the transceiver from the UE, and wherein the second message includes at least one of: an identifier (ID) of a second candidate cell within the one or more candidate cells, wherein the second candidate cell is associated with a failure of a compliance check operation performed by the UE; an index for the RRC reconfiguration message for the second candidate cell; or a fourth indication for indicating the failure of the compliance check operation.

In some embodiments, the second message is at least one of: a master cell group (MCG) failure information message; a secondary cell group (SCG) failure information message; or a UE assistance information message.

Some embodiments of the present application provide a target distributed unit (DU). The target DU includes a transceiver and a processor coupled to the transceiver; and the processor is configured to transmit information via the transceiver to a centralized unit (CU), wherein the information includes at least one of: at least one timing advance (TA) value related to at least one candidate cell within one or more candidate cells of a user equipment (UE); or at least one identifier (ID) of the at least one candidate cell.

In some embodiments, the information is transmitted to the CU via F1 interface.

In some embodiments, the processor of the target DU is configured to receive one or more reference signals via the transceiver from the UE.

In some embodiments, the processor of the target DU is configured to: monitor the one or more reference signals; and calculate the at least one TA value related to the at least one candidate cell based on the one or more reference signals.

In some embodiments, the one or more reference signals include at least one of: a preamble; or a sounding reference signal (SRS).

In some embodiments, in response to the one or more reference signals including the preamble, the processor of the target DU is configured to prohibit transmitting a response after receiving the preamble.

In some embodiments, the processor of the target DU is configured to generate configuration information regarding the one or more reference signals.

In some embodiments, the processor of the target DU is configured to transmit the configuration information regarding the one or more reference signals via the transceiver to the CU.

In some embodiments, the configuration information includes a configuration for a time-frequency domain resource associated with the one or more reference signals, and wherein the one or more reference signals are received on the time-frequency domain resource.

Some embodiments of the present application provide a method performed by a UE. The method includes: receiving a radio resource control (RRC) reconfiguration message, wherein the RRC reconfiguration message includes first configuration information regarding one or more candidate cells; after receiving the RRC reconfiguration message, getting one or more timing advance (TA) values related to the one or more candidate cells by performing one or more random access (RA) procedures or by transmitting one or more reference signals to the one or more candidate cells; and switching from a source cell to a first candidate cell within the one or more candidate cells, upon receiving a first indication associated with the first candidate cell from the source cell.

Some embodiments of the present application provide a method performed by a centralized unit (CU). The method includes: transmitting information to a user equipment (UE), wherein the information includes at least one of: configuration information regarding one or more candidate cells; at least one timing advance (TA) value related to at least one candidate cell within the one or more candidate cells; or at least one identifier (ID) of the at least one candidate cell.

Some embodiments of the present application provide a method performed by a target distributed unit (DU). The method includes: transmitting information to a centralized unit (CU), wherein the information includes at least one of: at least one timing advance (TA) value related to at least one candidate cell within one or more candidate cells of a user equipment (UE); or at least one identifier (ID) of the at least one candidate cell.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g., a base station (BS), a CU, or a DU).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present application.

FIG. 2 illustrates a schematic diagram of inter-cell Layer1/Layer2 (L1/L2) mobility in accordance with some embodiments of the present application.

FIG. 3 illustrates an exemplary signaling flow for lower layer based switching in accordance with some embodiments of the present application.

FIG. 4 illustrates an exemplary flowchart of getting TA in accordance with some embodiments of the present application.

FIGS. 5-8 illustrate exemplary flowcharts of performing a cell change procedure in accordance with some embodiments of the present application.

FIG. 9 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

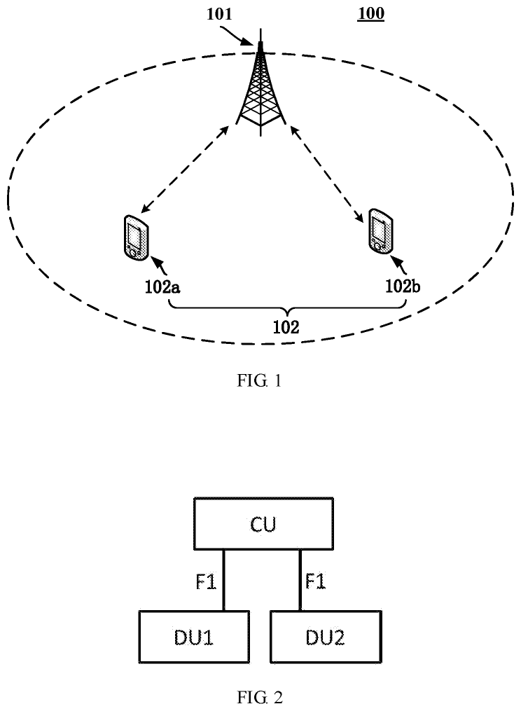

FIG. 1 illustrates a schematic diagram of a wireless communication system according to some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g., UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

UE 102, e.g., UE 102a and UE 102b, should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In 3GPP Release 18, it has been discussed to support an inter-cell mobility based on Layer1/Layer2 (L1/L2) signaling. In particular, a UE can be provided in advance with configurations from multiple cells, and a BS (e.g., gNB) may switch a UE to a new cell using L1/L2 signaling taking into account the received physical layer measurement result. In accordance with 3GPP standard documents, a BS may consist of a BS-centralized unit (CU) and one or more BS-distributed unit(s) (DU(s)). A BS-CU and a BS-DU are connected via F1 interface which is a logical interface. One BS-DU is connected to only one BS-CU.

FIG. 2 illustrates a schematic diagram of inter-cell Layer1/Layer2 (L1/L2) mobility in accordance with some embodiments of the present application. As shown in FIG. 2, CU may communicate with two DUs, i.e., DU1 or DU2, via F1 interfaces. CU in FIG. 2 may implement legacy mobility decision based on Layer 3 (L3) measurement result. DU1 or DU2 in FIG. 2 may implement L1/L2 mobility decision based on physical layer measurement result.

Compared to legacy L3 mobility, L1/L2 mobility is considered faster with less processing delay and signaling delay. In legacy L3 mobility, a CU (e.g., CU as shown in FIG. 2) makes the mobility decision based on received radio resource management (RRM) measurement report. Different than legacy L3 mobility, in L1/L2 mobility, a DU (e.g., DU1 or DU2 as shown in FIG. 2) makes the mobility decision based on physical layer measurement result, e.g., carried in a channel state information (CSI) report. Besides, in legacy L3 mobility, the handover command is sent via an RRC message from the SN CU to a UE, while in L1/L2 mobility, the “handover” command is sent via L1/L2 signaling (e.g., downlink control information (DCI) or a medium access control (MAC) control element (CE)) from the DU to a UE. The “handover” command in L1/L2 mobility can be about cell activation or deactivation, e.g., activate a new serving PCell while deactivate the old serving PCell.

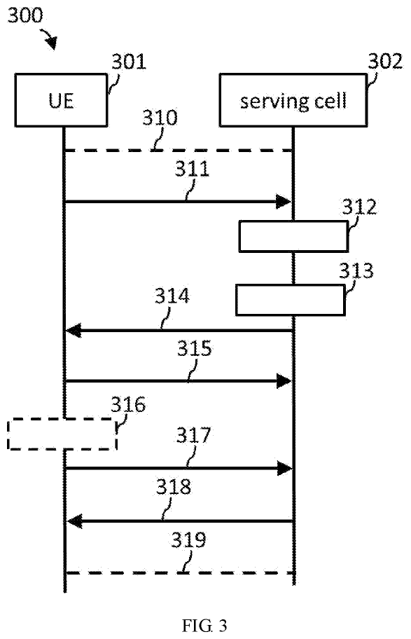

FIG. 3 illustrates an exemplary signaling flow for lower layer based switching in accordance with some embodiments of the present application. The signaling flow in FIG. 3 illustrates the procedure of dynamic switching. The dynamic switching may be triggered by a lower layer command. The possible ways include DCI or MAC CE to activate cell change. L1 measurement result(s) may be used to determine whether the cell change is triggered or not. Therefore, DCI may be used. Otherwise, physical layer needs to indicate the decision of switching to MAC layer. Then, MAC entity may generate the MAC CE and deliver to physical layer.

In particular, in exemplary signaling flow 300 as shown in FIG. 3, in operation 310, UE 301 accesses serving cell 302. In operation 311, UE 301 reports L3 measurement result(s) based on the configuration from serving cell 302.

In operation 312, serving cell 302 decides to switch UE 301 to a candidate cell based on the measurement result(s). Then, in operation 313, the target DU(s) will prepare the configuration for one or more than one candidate cell.

In operation 314, serving cell 302 transmits an RRC reconfiguration message including one or more than one candidate cell to UE 301. In operation 315, UE 301 responses to serving cell 302 by transmitting an RRC reconfiguration complete message.

In operation 316 (optional), UE 301 may ensure UL or DL synchronization before receiving DCI or MAC CE indication. For example, UE 301 may get TA via a random access (RA) procedure. In operation 317, UE 301 may report L1 measurement result(s) for dynamic switching purpose.

In operation 318, serving cell 302 transmits lower layer command to UE 301. In operation 319, UE 301 can apply the RRC reconfiguration message and transmit/receive the data upon receiving a lower layer command.

Currently, issues of an UL synchronization failure and compliance check in a lower layer-based mobility case have not been solved. Embodiments of the present application aim to solve such issues. For instance, some embodiments of the present application study a use case in which a UE receives the configuration for candidate cell(s). Before executing a primary cell of a master or secondary cell group (SpCell) change or executing a secondary cell (SCell) change, the UE is expected to get TA via an RA procedure. Some embodiments of the present application study a UE's behaviors in a case that a failure of RA for getting TA happens. Some embodiments of the present application study a mechanism of how to handle a case that TA is unavailable when the UE receives DCI or MAC CE indication. Some embodiments of the present application study a mechanism of when to perform compliance check and how to handle the case of a compliance check failure.

Some embodiments of the present application study a use case in which a UE transmits a preamble or SRS based on configuration information. For example, a neighbour cell may monitor the preamble or SRS and calculate the TA. The neighbour cell may transfer the TA to the serving cell. Then, the serving cell may transmit the TA to the UE. Some embodiments of the present application study a mechanism in which a UE may transmit preamble or SRS based on configuration information to get TA, and the UE may get the TA from the serving cell after the serving cell gets the TA from the target cell.

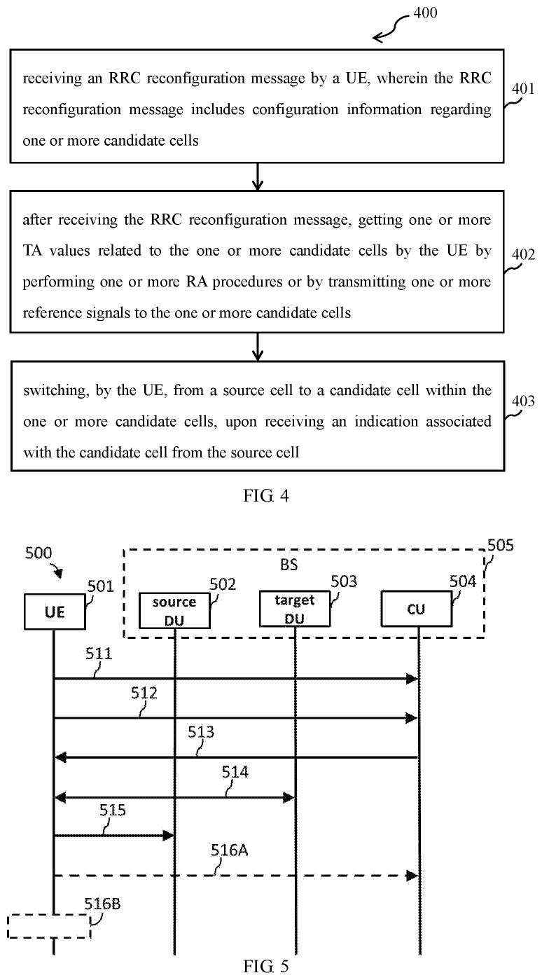

In particular, in embodiments of FIGS. 4-9 of the present application, both inter-DU mobility scenario and intra-DU mobility scenario are considered. Inter-DU mobility means that a connection to a CU remains the same, while a UE may change from a source cell related to a source DU to a target cell related to a target DU due to mobility, while both the source DU and the target DU are managed by the CU. Intra-DU mobility means that a connection to a CU remains the same, while a UE may change from a source cell to a target cell related to the same DU due to mobility. More details will be illustrated in following text in combination with the appended drawings.

FIG. 4 illustrates an exemplary flowchart of getting TA in accordance with some embodiments of the present application. The exemplary flowchart 400 in the embodiments of FIG. 4 may be performed by a UE (e.g., UE 102 as shown and illustrated in FIG. 1). Although described with respect to a UE, it should be understood that other devices may be configured to perform a method similar to that of FIG. 4. Details described in all other embodiments of the present application are applicable for the embodiments of FIG. 4. Moreover, details described in the embodiments of FIG. 4 are applicable for all the embodiments of FIGS. 1-3 and 5-9.

In the exemplary flowchart 400 as shown in FIG. 4, in operation 401, a UE may receive an RRC reconfiguration message. The RRC reconfiguration message includes configuration information regarding one or more candidate cells (denoted as configuration #1 for simplicity). In some embodiments, a target DU (e.g., DU1 as shown and illustrated in FIG. 2) generates configuration #1 and transmits configuration #1 to a CU (e.g., CU as shown and illustrated in FIG. 2) via F1 interface. Then, the CU transmits configuration #1 to the UE in the RRC reconfiguration message, for example, through a source DU (e.g., DU2 as shown and illustrated in FIG. 2).

In operation 402 as shown in FIG. 4, after receiving the RRC reconfiguration message, the UE may get one or more TA values related to the one or more candidate cells “by performing one or more RA procedures to the one or more candidate cells” or “by transmitting one or more reference signals to the one or more candidate cells”.

In operation 403 as shown in FIG. 4, the UE may switch from a source cell to a candidate cell (denoted as candidate cell #1 for simplicity) within the one or more candidate cells, upon receiving an indication (denoted as indication #1 for simplicity) associated with candidate cell #1 from the source cell. Indication #1 may be associated with a cell change or a cell switch to candidate cell #1.

In some embodiments, the RRC reconfiguration message received in operation 401 includes at least one of:
(1) A value of a timer for RA for getting TA. The timer may be denoted as timer #1 for simplicity. For example, if a timer “T” is configured for a RA procedure for getting TA, the UE may start the timer upon initiation of the RA procedure for getting TA. The UE may stop the timer upon completing the RA procedure for
(2) A maximum total number of preamble transmissions. Once the maximum total number of preamble transmissions is reached, the UE considers a RA procedure for getting TA as failed.

In an embodiment, after receiving the RRC reconfiguration message including the value of timer #1, the UE may start timer #1 in response to initiating a RA procedure for getting TA (denoted as RA procedure #1 for simplicity) within the one or more RA procedures, and timer #1 is associated with RA procedure #1. In an embodiment, the UE may stop timer #1, in response to successfully getting a TA value related to a candidate cell within the one or more candidate cells by performing RA procedure #1 to the candidate cell. In an embodiment, the UE may consider RA procedure #1 as failed, in response to expiry of timer #1.

In an embodiment, after receiving the RRC reconfiguration message including the maximum total number of preamble transmissions, the UE may consider that a RA procedure for getting TA (denoted as RA procedure #2 for simplicity) within the one or more RA procedures is failed, in response to reaching the maximum total number of preamble transmissions during RA procedure #2. The maximum total number of preamble transmissions is associated with RA procedure #2.

In some embodiments, in response to failing to get the one or more TA values by performing the one or more RA procedures (e.g., a failure of RA for getting TA, which may also be named as “a RA failure” or the like), the UE may perform one of:
(1) The UE may transmit a message (denoted as message #1 for simplicity) to the source cell. For instance, a new trigger condition is introduced to transmit message #1 which includes failure related information via an RRC layer or a MAC layer. For example, the UE reports the failure related information to the serving cell upon a failure of RA for getting TA. In some embodiments, message #1 includes at least one of:
   a) An indication for indicating that the UE fails to get the one or more TA values related to the one or more candidate cells.
   b) An indication for indicating that the one or more RA procedures are for getting the one or more TA values. This indication could indicate that the intention of the one or more RA procedures is for getting TA. This indication may be added in message #1 triggered by the failure of RA for getting TA. A specific example is described in the embodiments of FIG. 5 as follows.
(2) The UE may suspend configuration #1 which is included in the RRC reconfiguration message. Then, a BS (e.g., gNB) may reconfigure configuration information regarding the one or more candidate cells.
(3) The UE may re-initiate the one or more RA procedures to the one or more candidate cells for getting TA after a time period. For example, the time period may be (pre-)configured by the BS (e.g., gNB). In this way, UE may not suspend configuration #1. That is, the UE does not apply such configuration information even receiving the DCI or MAC CE indication (e.g., indication #1).

In some embodiments, indication #1 in operation 403 is included in an RRC message. For example, the CU may transmit an RRC message including indication #1 to the UE.

In some other embodiments, indication #1 is included in DCI or a MAC CE. For example, the CU may transmit a further indication to a source DU (e.g., DU2 as shown and illustrated in FIG. 2) managed by the CU, to indicate the source DU to transmit indication #1 to the UE. For instance, the source DU may decide to activate a cell change to a candidate cell. The source DU may transmit DCI or MAC CE including indication #1 to the UE directly.

In some embodiments, in response to candidate cell #1 being a PSCell, indication #1 may be received by the UE from at least one of a SN or a MN. In some embodiments, the UE may start a handover timer (e.g., T304 as defined in 3GPP standard documents) upon an RRC layer of the UE receiving indication #1 from a lower layer of the UE.

In some embodiments, upon receiving indication #1, the UE may determine whether a TA value (denoted as TA value #1 for simplicity) which is related to candidate cell #1 is available or not. In response to determining that TA value #1 is unavailable, the UE may perform one of:
(1) The UE may prohibit initiating another RA procedure (denoted as RA procedure #3 for simplicity) to candidate cell #1 for getting TA, upon determining that TA value #1 is unavailable.
(2) The UE may declare a RA failure.
(3) The UE may declare a mobility failure.
(4) The UE may determine whether “elapsed time since TA value #1 is considered as unavailable” is less than or equal to a time period (e.g., which is (pre-)configured by the BS), and may prohibit initiating RA procedure #3 in response to determining that the elapsed time is less than or equal to the time period.
(5) The UE may initiate RA procedure #3 upon determining that TA value #1 is unavailable.

In some embodiments, to determine whether TA value #1 is available or not, the UE may determine whether TA value #1 has been gotten or not. If TA value #1 has not been gotten, the UE may determine that TA value #1 is unavailable. If TA value #1 has been gotten, the UE may further determine whether TA value #1 is valid or not. For example, the UE may determine whether TA value #1 is valid based on a (pre-)configured time period or based on a change of reference signal received power (RSRP). If the UE determines that TA value #1 is invalid, the UE may determine that TA value #1 is unavailable.

In some embodiments, the UE may transmit failure related information to candidate cell #1, in response to successfully getting TA value #1 by performing RA procedure #3. The failure related information may indicate that TA value #1 is unavailable before initiating RA procedure #3. A specific example is described in the embodiments of FIG. 6 as follows.

In some embodiments, the UE may perform a compliance check operation at any of following time points:
(1) upon receiving the RRC reconfiguration message in operation 401 as shown in FIG. 4;
(2) after receiving the RRC reconfiguration message and before initiating the one or more RA procedures for getting TA;
(3) after receiving the RRC reconfiguration message and before the UE being triggered to perform the one or more RA procedures for getting TA;
(4) upon initiating the one or more RA procedures for getting TA; or
(5) upon the UE being triggered to perform the one or more RA procedures for getting TA.

In some embodiments, in response to successful completion of the compliance check operation, the UE may perform the one or more RA procedures for getting TA.

In some embodiments, in response to successful completion of the compliance check operation and upon receiving indication #1, the UE may perform at least one of the following:
(1) A lower layer of the UE may transmit indication #1 to an RRC layer of the UE.
(2) The RRC layer of the UE may apply “configuration information regarding candidate cell #1 within configuration #1”.

In some embodiments, in response to occurrence of a failure of the compliance check operation, the UE may transmit a further message (denoted as message #2 for simplicity) to the source cell. A failure of the compliance check operation may also be named as “a compliance check failure” or the like. Message #2 may include at least one of:
(1) An ID of a candidate cell (denoted as candidate cell #2 for simplicity) within the one or more candidate cells. Candidate cell #2 is associated with the failure of the compliance check operation.
(2) An index for the RRC reconfiguration message for candidate cell #2.
(3) An indication which indicates the failure of the compliance check operation.

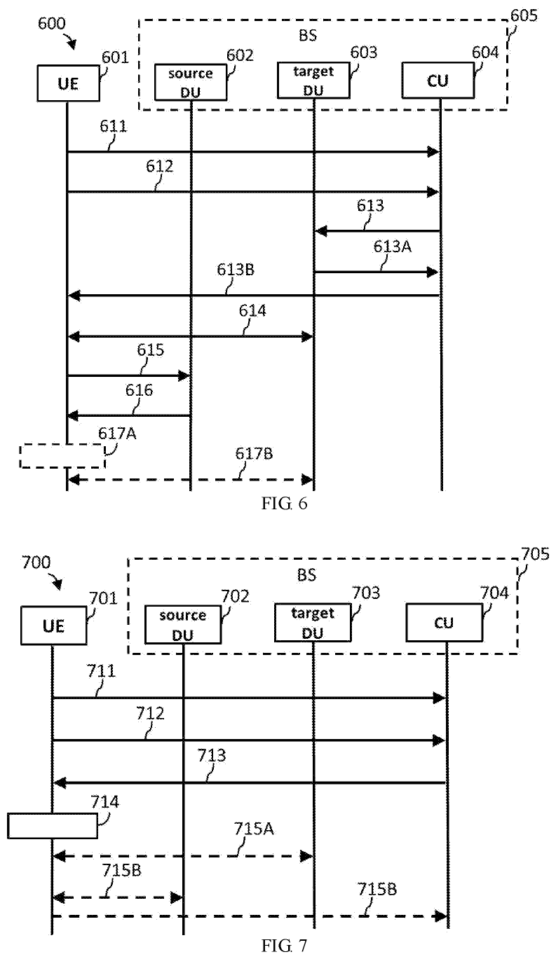

In some embodiments, message #2 may be: a MCG failure information message; a SCG failure information message; and/or a UE assistance information message. A specific example is described in the embodiments of FIG. 7 as follows.

In some embodiments, the one or more reference signals, which are transmitted to the one or more candidate cells in operation 402 as shown in FIG. 4, include a preamble and/or a SRS.

In some embodiments, the UE may receive configuration information (denoted as configuration #3 for simplicity) regarding the one or more reference signals. For example, configuration #3 may be generated by candidate cell #1 or other candidate cell within the one or more candidate cells. The UE may transmit the one or more reference signals to candidate cell #1 based on configuration #3.

In an embodiment, configuration #3 includes a configuration for a time-frequency domain resource associated with a SRS. The UE may transmit the SRS to candidate cell #1 on this time-frequency domain resource.

In another embodiment, configuration #3 includes a configuration for a time-frequency domain resource associated with a preamble. The UE may transmit the preamble to candidate cell #1 on this time-frequency domain resource.

In some embodiments, the UE may transmit the preamble to candidate cell #1 during a time gap. In some embodiments, the UE may prohibit expecting to monitor a response (e.g., a random access response (RAR)) after transmitting the preamble. That is, the UE does not expect to monitor a response (e.g., an RAR) after transmitting the preamble.

In some embodiments, the UE may receive another message (denoted as message #3 for simplicity) from the source cell. Message #3 may include at least one of:
(1) At least one TA value related to at least one candidate cell within the one or more candidate cells.
(2) At least one ID of the at least one candidate cell.

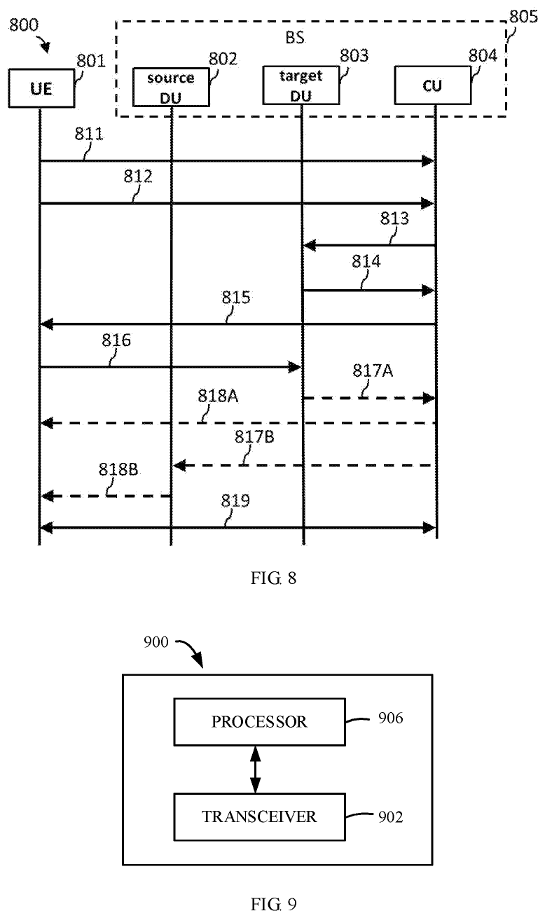

In some embodiments, message #3 is at least one of: DCI; a MAC CE; or an RRC message. For example, multiple TA values and multiple IDs of corresponding candidate cells may be carried in one single piece of DCI, in one single MAC CE, or in one single RRC message. A specific example is described in the embodiments of FIG. 8 as follows.

Some other embodiments of the present application refer to an exemplary flowchart performed by a CU (e.g., CU as shown and illustrated in FIG. 2). Although described with respect to a CU, it should be understood that other devices may be configured to perform a similar flowchart. Details described in all other embodiments of the present application are applicable for this exemplary flowchart.

In particular, in the exemplary flowchart, a CU transmits information to a UE (e.g., UE 102 as shown and illustrated in FIG. 1). The information may include at least one of:
(1) Configuration information regarding one or more candidate cells (e.g., configuration #1 as described in the embodiments of FIG. 4). In some embodiments, a target DU (e.g., DU1 as shown and illustrated in FIG. 2) generates configuration #1 and transmits configuration #1 to the CU via F1 interface. Then, the CU transmits configuration #1 to the UE in the RRC reconfiguration message, for example, through a source DU (e.g., DU2 as shown and illustrated in FIG. 2).
(2) At least one TA value related to at least one candidate cell within the one or more candidate cells.
(3) At least one ID of the at least one candidate cell.

In some embodiments, the information is included in at least one of: DCI; a MAC CE; or an RRC message.

In some embodiments, the CU may receive, from a target DU (e.g., DU1 as shown and illustrated in FIG. 2) which is managed by the CU, at least one of:
(1) The at least one TA value related to the at least one candidate cell within the one or more candidate cells.
(2) The at least one ID of the at least one candidate cell. A specific example is described in the embodiments of FIG. 8 as follows.

In some embodiments, the CU may transmit an RRC message to the UE. The RRC message may include an indication (e.g., indication #1 as described in the embodiments of FIG. 4) associated with a cell change to a candidate cell (e.g., candidate cell #1 as described in the embodiments of FIG. 4) within the one or more candidate cells.

In some other embodiments, the CU may transmit a further indication to a source DU (e.g., DU2 as shown and illustrated in FIG. 2) managed by the CU. The further indication indicates the source DU to transmit “indication #1 associated with a cell change to candidate cell #1” to the UE. For example, the source DU may decide to activate a cell change to a candidate cell. The source DU may transmit DCI or MAC CE including indication #1 to the UE directly.

In some embodiments, in response to candidate cell #1 being a PSCell, the CU is associated with a SN or a MN. A specific example is described in the embodiments of FIG. 6 as follows.

In some embodiments, the CU may receive a message (e.g., message #1 as described in the embodiments of FIG. 4) from the UE. Message #1 may include at least one of:
(1) An indication for indicating that the UE fails to get one or more TA values related to the one or more candidate cells.
(2) An indication for indicating that one or more RA procedures performed by the UE are for getting the one or more TA values.

In some embodiments, the CU may receive a further message (e.g., message #2 as described in the embodiments of FIG. 4) from the UE. Message #2 includes at least one of:
(1) An ID of a candidate cell (e.g., candidate cell #2 as described in the embodiments of FIG. 4) within the one or more candidate cells. Candidate cell #2 is associated with a failure of a compliance check operation performed by the UE.
(2) An index for the RRC reconfiguration message for candidate cell #2.
(3) An indication which indicates the failure of the compliance check operation.

In some embodiments, message #2 is at least one of: a MCG failure information message; a SCG failure information message; or a UE assistance information message. A specific example is described in the embodiments of FIG. 7 Some additional embodiments of the present application refer to an exemplary flowchart performed by a target DU (e.g., DU1 or DU2 as shown and illustrated in FIG. 2). Although described with respect to a target DU, it should be understood that other devices may be configured to perform a similar flowchart. Details described in all other embodiments of the present application are applicable for this exemplary flowchart.

In particular, in the exemplary flowchart, a target DU may transmit information to a CU (e.g., CU as shown and illustrated in FIG. 2). The information includes at least one of:
(1) At least one TA value related to at least one candidate cell within one or more candidate cells of a UE (e.g., UE 102 as shown and illustrated in FIG. 1).
(2) At least one ID of the at least one candidate cell.

In some embodiments, the information is transmitted to the CU via F1 interface.

In some embodiments, the target DU may receive one or more reference signals from the UE. In some embodiments, the target DU may monitor the one or more reference signals, and calculate the at least one TA value related to the at least one candidate cell based on the one or more reference signals.

In some embodiments, the one or more reference signals include a preamble and/or a SRS. In an embodiment, in response to the one or more reference signals including the preamble, the target DU may prohibit transmitting a response (e.g., an RAR) after receiving the preamble.

In some embodiments, the target DU may generate configuration information regarding the one or more reference signals (e.g., configuration #3 as described in the embodiments of FIG. 4). In some embodiments, the target DU may transmit the configuration information regarding the one or more reference signals to the CU, e.g. via F1 interface.

In some embodiments, the configuration information includes a configuration for a time-frequency domain resource associated with the one or more reference signals. The one or more reference signals may be received on the time-frequency domain resource. A specific example is described in the embodiments of FIG. 8 as follows.

FIG. 5 illustrates an exemplary flowchart of performing a cell change procedure in accordance with some embodiments of the present application. Details described in all other embodiments of the present application are applicable for the embodiments shown in FIG. 5. It should be appreciated by persons skilled in the art that the sequence of the operations in exemplary flowchart 500 in FIG. 5 may be changed and some of the operations in exemplary flowchart 500 in FIG. 5 may be eliminated or modified, without departing from the spirit and scope of the disclosure.

As show in FIG. 5, BS 505 is in CU-DU architecture, and includes CU 504, source DU 502, and target DU 503. In the embodiments of FIG. 5, a cell change of UE 501 may refer to an Intra-DU case in which a source cell and a target cell in the same DU or refer to an Inter-DU case in which a source cell and a target cell are located at different DUs. For instance, the flowchart 500 as shown in FIG. 5 only shows a cell change in an Inter-DU case for the exemplary purpose.

In the exemplary flowchart 500 as shown in FIG. 5, in operation 511, UE 501 reports an indication, which indicates that UE 501 supports the capability of DCI or MAC CE based cell change, to the serving cell, e.g., related to CU 504.

In operation 512, UE 501 reports measurement result(s) via an RRC message to the serving cell, e.g., related to CU 504. For example, UE 501 may report the measurement result(s) based on the RRC reconfiguration including measurement configuration(s).

In operation 513, UE 501 receives the configuration(s) for candidate cell(s) from CU 504, e.g., in an RRC reconfiguration message. In some embodiments, the configuration(s) may include a value of a timer (e.g., a length of “T”) and/or a maximum total number of preamble transmissions. Some parameters in the configuration(s) for candidate cell(s) are generated from target DU 503.

In an embodiment, if the timer (e.g., “T”) is configured, UE 501 may start the timer upon initiation of a RA procedure for getting TA. UE 501 may stop the timer upon completing the RA procedure for getting TA. In some cases, “a RA procedure for getting TA” may also be named as “a RA procedure for getting early TA” or the like.

The maximum total number of preamble transmissions may be used to determine whether a RA procedure fails or not. In an embodiment, if the configuration(s) includes the maximum total number of preamble transmissions, once a total number of preamble transmissions is reached, UE 501 considers that the RA procedure is failed.

In operation 514, after UE 501 receives the configuration(s) for candidate cell(s) from CU 504, UE 501 performs RA procedure(s) to the candidate cell(s) for getting TA. For example, UE 501 performs a RA procedure to target DU 503 as shown in FIG. 5.

In operation 515, UE 501 performs the measurement for the serving cell and candidate cell(s) and reports L1 measurement result(s) to source DU 502.

In some embodiments, there is a time period between receiving the configuration(s) for candidate cell(s) and receiving DCI or MAC CE indication. UE 501 is not aware of the time point of receiving the DCI or MAC CE indication. UE 501 will perform RA procedure(s) for getting TA. However, UE 501 may fail to get TA via the RA procedure(s). If the timer (e.g., “T”) is configured, UE 501 starts the timer upon initiation of the RA procedure(s) for getting TA. UE 501 stops the timer upon completing the RA procedure(s) for getting TA. If the maximum total number of preamble transmissions is configured, once the maximum total number of preamble transmissions is reached, UE 501 considers that the RA procedure(s) is failed.

In some embodiments, after UE 501 fails to get TA via the RA procedure(s), UE 501 may do the following behaviors in different embodiments, i.e., operation 516A or operation 516B.

In operation 516A (optional), UE 501 reports failure related information to the serving cell, e.g., related to a SpCell. The failure related information can be carried in an RRC message or MAC CE.

In some embodiments, a new trigger condition is introduced to transmit a message (e.g., message #1 as described in the embodiments of FIG. 4) including the failure related information. For example, UE 501 reports the failure related information to the serving cell upon a failure of RA procedure(s) for getting TA.

In some embodiments, a new indication for getting TA purpose can be added in the message (e.g., message #1) triggered by the failure of RA procedure(s) for getting TA. The indication could indicate that the intention of RA procedure(s) is for getting TA.

In operation 516B (optional), there may be following two options in different embodiments as below, i.e., Option 1 and Option 2.
(1) Option 1: UE 501 may suspend the configuration(s) for the candidate cell(s). Then, BS 505 may reconfigure the configuration(s) of candidate cell(s).
(2) Option 2: UE 501 may re-perform RA procedure(s) after a time period configured by BS 505. In this way, UE 501 may not suspend the configuration(s) for the candidate cell(s).

FIG. 6 illustrates another exemplary flowchart of performing a cell change procedure in accordance with some embodiments of the present application. Details described in all other embodiments of the present application are applicable for the embodiments shown in FIG. 6. It should be appreciated by persons skilled in the art that the sequence of the operations in exemplary flowchart 600 in FIG. 6 may be changed and some of the operations in exemplary flowchart 600 in FIG. 6 may be eliminated or modified, without departing from the spirit and scope of the disclosure.

As show in FIG. 6, BS 605 is in CU-DU architecture, and includes CU 604, source DU 602, and target DU 603. In the embodiments of FIG. 6, a cell change of UE 601 may refer to an Intra-DU case in which a source cell and a target cell in the same DU or refer to an Inter-DU case in which a source cell and a target cell are located at different DUs. For instance, the flowchart 600 as shown in FIG. 6 only shows a cell change in an Inter-DU case for the exemplary purpose.

In the exemplary flowchart 600 as shown in FIG. 6, in operation 611, UE 601 reports an indication, which indicates that UE 601 supports the capability of DCI or MAC CE based cell change, to the serving cell, e.g., related to CU 604.

In operation 612, UE 601 reports measurement result(s) via an RRC message to the serving cell, e.g., related to CU 604. For example, UE 601 may report the measurement result(s) based on the RRC reconfiguration including measurement configuration(s).

In operation 613, CU 604 may transmit a request to prepare the configuration(s) for candidate cell(s) to target DU 603. In operation 613A, target DU 603 generates configuration(s) for candidate cell(s) and transmits the configuration(s) for the candidate cell(s) to CU 604, e.g., via F1 interface. In operation 613B, CU 604 transmits the configuration(s) for the candidate cell(s) in an RRC reconfiguration message to UE 601 (e.g., through source DU 602).

In operation 614, after UE 601 receives the configuration(s) for the candidate cell(s) from CU 604, UE 601 performs RA procedure(s) to candidate cell(s) (e.g., related to target DU 603) for getting TA. In some cases, “a RA procedure for getting TA”may also be named as “a RA procedure for getting early TA”or the like.

In operation 615, UE 601 performs the measurement for the serving cell and candidate cell(s) (e.g., related to target DU 603) and reports L1 measurement result(s) to source DU 602.

In some embodiments, in operation 616, source DU 602 may transmit DCI or MAC CE indication to UE 601, to trigger a cell change procedure. For example, source DU 602 may decide to activate a cell change to a candidate cell. Source DU 602 may transmit DCI or MAC CE including indication #1 (as described in the embodiments of FIG. 4) to UE 601 directly. In some embodiments, CU 604 may transmit an indication to source DU 602, e.g., via F1 interface, to indicates source DU 602 to transmit “an indication associated with a cell change to a candidate cell within the candidate cell(s)”to UE 601.

In some embodiments, there may be a time period between receiving the configuration(s) for candidate cell(s) and receiving the DCI or MAC CE indication. UE 601 is not aware of the time point of receiving the DCI or MAC CE indication. Therefore, the issue when to perform a RA procedure for getting TA needs to be addressed. “To get TA” means that UE 601 needs to ensure UL synchronization before executing a cell change procedure.

If the candidate cell is a PSCell, the DCI or MAC CE indication may be transmitted by a SN or a MN.

In some embodiments, UE 601 may determine whether a TA value related to a candidate cell is available or not when receiving the DCI or MAC CE indication. For example, UE 601 may determine whether the TA value related to the candidate cell has been gotten or not. If the TA value has not been gotten, UE 601 may determine that the TA value is unavailable. If the TA value has been gotten, UE 601 may further determine whether the TA value is valid or not. If UE 601 determines that the TA value is invalid, UE 601 may determine that the TA value is unavailable.

In some embodiments, UE 601 starts a handover timer (e.g., T304 as defined in 3GPP standard documents) when an RRC layer of UE 601 receiving the DCI or MAC CE indication from a lower layer of UE 601.

In some embodiments, after receiving the DCI or MAC CE indication in operation 616B, UE 501 may do the following behaviors in different embodiments, i.e., operation 617A or operation 617B.

In operation 617A (optional), there may be following two options in different embodiments as below, i.e., Option A and Option B.
(1) Option A: if UE 601 determines that the TA value related to the candidate cell is unavailable when receiving the DCI or MAC CE indication, UE 601 does not perform a RA procedure (e.g., RA procedure #3 as described in the embodiments of FIG. 4), and UE 601 may declare an RA failure or a mobility failure.
(2) Option B: if UE 601 determines that the TA value related to the candidate cell is unavailable when receiving the DCI or MAC CE indication and if the elapsed time since the TA value is considered as unavailable is less than or equal to a time period, UE 601 does not perform a RA procedure (e.g., RA procedure #3), and UE 601 may declare an RA failure or a mobility failure.

In operation 617B (optional), if UE 601 determines that the TA value related to the candidate cell is unavailable when receiving the DCI or MAC CE indication, UE 601 performs a RA procedure (e.g., RA procedure #3) to the candidate cell, e.g., related to target DU 603. If successfully performing the RA procedure, UE 601 will report the failure related information to the target cell (i.e., the candidate cell, e.g., related to target DU 603). The failure related information may indicate that the TA value related to the target cell is unavailable before initiating RA procedure #3.

FIG. 7 illustrates another exemplary flowchart of performing a cell change procedure in accordance with some embodiments of the present application. Details described in all other embodiments of the present application are applicable for the embodiments shown in FIG. 7. It should be appreciated by persons skilled in the art that the sequence of the operations in exemplary flowchart 700 in FIG. 7 may be changed and some of the operations in exemplary flowchart 700 in FIG. 7 may be eliminated or modified, without departing from the spirit and scope of the disclosure.

As show in FIG. 7, BS 705 is in CU-DU architecture, and includes CU 704, source DU 702, and target DU 703. In the embodiments of FIG. 7, a cell change of UE 701 may refer to an Intra-DU case in which a source cell and a target cell in the same DU or refer to an Inter-DU case in which a source cell and a target cell are located at different DUs. For instance, the flowchart 700 as shown in FIG. 7 only shows a cell change in an Inter-DU case for the exemplary purpose.

In the exemplary flowchart 700 as shown in FIG. 7, in operation 711, UE 701 reports an indication, which indicates that UE 701 supports the capability of DCI or MAC CE based cell change, to the serving cell, e.g., related to CU 704.

In operation 712, UE 701 reports measurement result(s) via an RRC message to the serving cell, e.g., related to CU 704. For instance, UE 701 may report the measurement result(s) based on the RRC reconfiguration including measurement configuration(s).

In operation 713, UE 701 receives the configuration(s) for candidate cell(s) from CU 704, e.g., in an RRC reconfiguration message. In some embodiments, the configuration(s) for candidate cell(s) includes a value of a timer (e.g., a length of “T”) and/or a maximum total number of preamble transmissions, which is used to determine whether a RA procedure fails or not. In some embodiments, target DU 703 generates the configuration(s) for candidate cell(s) and transmits the configuration(s) for the candidate cell(s) to CU 704, e.g., via F1 interface. Then, CU 704 transmits the configuration(s) for the candidate cell(s) in the RRC reconfiguration message to UE 701 (e.g., through source DU 702) in operation 713.

In operation 714, after UE 701 receives the configuration(s) for candidate cell from the serving cell, UE 701 needs to perform a compliance check operation for the RRC reconfiguration message. In some embodiments, UE 701 may perform the compliance check operation at any of the following time points.
(1) UE 701 performs the compliance check operation upon receiving the RRC reconfiguration message (which includes the configuration(s) of candidate cell(s)).
(2) UE 701 performs the compliance check operation after receiving the RRC reconfiguration message and before UE 701 initiating the RA procedure(s) for getting TA.
(3) UE 701 performs the compliance check operation after receiving the RRC reconfiguration message and before UE 701 being triggered to perform the RA procedure(s) for getting TA.
(4) UE 701 performs the compliance check operation upon UE 701 initiating the RA procedure(s) for getting TA.
(5) UE 701 performs the compliance check operation upon UE701 being triggered to perform the RA procedure(s) for getting TA.

After operation 714, UE 501 may do the following behaviors in different embodiments, i.e., operation 715A or operation 715B.

In operation 715A (optional), in some embodiments, after UE 701 successfully performs the compliance check operation, UE 701 performs RA procedure(s) for getting TA to the candidate cell(s), e.g., related to target DU 703.

In some embodiments, after receiving a lower layer command, e.g., DCI or MAC CE indication to activate cell change, the lower layer of UE 701 should indicate the DCI or MAC CE indication to an RRC layer of UE 701. Then, the RRC layer of UE 701 may apply the configuration(s) for the candidate cell(s).

In operation 715B (optional), if UE 701 fails to complete the compliance check operation, UE 701 may report the failure related information to the source cell. For instance, for SpCell change or SCell change, the failure related information may include an ID of the candidate cell, the index for the RRC reconfiguration of the candidate cell, and/or a compliance check failure indication. For example, UE 701 may do the following behaviors in different embodiments of operation 715B, to report the failure related information. The failure related information can be reported to CU 704 via an RRC message or to source DU 702 via MAC CE.
(1) UE 701 may transmit MCGfailureinformation message including the failure related information.
(2) UE 701 may transmit SCGfailureinformation message including the failure related information.
(3) UE 701 may transmit UEassistanceinformation message including the failure related information. For instance, for SpCell change or SCell change, the UEassistanceinformation message may include the failure related information, which includes an ID of the candidate cell, the index for the RRC reconfiguration of the candidate cell, and/or a compliance check failure indication.

FIG. 8 illustrates another exemplary flowchart of performing a cell change procedure in accordance with some embodiments of the present application. Details described in all other embodiments of the present application are applicable for the embodiments shown in FIG. 8. It should be appreciated by persons skilled in the art that the sequence of the operations in exemplary flowchart 800 in FIG. 8 may be changed and some of the operations in exemplary flowchart 800 in FIG. 8 may be eliminated or modified, without departing from the spirit and scope of the disclosure.

As show in FIG. 8, BS 805 is in CU-DU architecture, and includes CU 804, source DU 802, and target DU 803. In the embodiments of FIG. 8, a cell change of UE 801 may refer to an Intra-DU case in which a source cell and a target cell in the same DU or refer to an Inter-DU case in which a source cell and a target cell are located at different DUs. For instance, the flowchart 800 as shown in FIG. 8 only shows a cell change in an Inter-DU case for the exemplary purpose.

In the exemplary flowchart 800 as shown in FIG. 8, in operation 811, UE 801 reports an indication, which indicates that UE 801 supports the capability of DCI or MAC CE based cell change, to the serving cell, e.g., related to CU 804.

In operation 812, UE 801 reports measurement result(s) via an RRC message to the serving cell, e.g., related to CU 804. For instance, UE 801 may report the measurement result(s) based on the RRC reconfiguration including measurement configuration(s).

In operation 813, CU 804 transmits a request for cell change to a target cell, e.g., related to target DU 803, via F1 interface. In some embodiments, CU 804 requests target DU 803 to provide configuration(s) of getting TA. In some cases, target DU 803 may also be named as “a neighbour cell” or “a candidate cell” or “a candidate target cell”or the like.

In operation 814, the target cell, e.g., related to target DU 803, transmits a response to CU 804. In some embodiments, the target cell may provide the configuration(s) of a SRS and/or a preamble. Regarding the configured SRS, a time-frequency domain resource may be also configured. UE 801 can transmit the SRS based on the configured time-frequency domain resource in operation 816 as described below. Regarding the configured preamble, UE 801 can transmit the preamble in a configured time-frequency domain resource or in a time gap in operation 816 as described below. After UE 801 transmits the preamble, UE 801 is not expected to monitor a response, e.g., an RAR.

In some embodiments, in operation 814, target DU 803 generates the configuration(s) for candidate cell(s) and transmits the configuration(s) for the candidate cell(s) to CU 804, e.g., via F1 interface.

In operation 815, after receiving the response from the target cell, e.g., related to target DU 803, CU 804 transmits the RRC reconfiguration message including “the configuration(s) for candidate cell(s)” and/or “the configuration(s) of a SRS and/or a preamble”to UE 801 (e.g., through source DU 802).

In operation 816, after receiving the configuration(s) for the candidate cell(s) and/or the configuration(s) of a SRS and/or a preamble from CU 804, UE 801 may transmit the SRS and/or the preamble to the target cell, e.g., related to target DU 803, based on the configuration(s) for the candidate cell(s).

In some embodiments, target DU 803 may monitor the SRS and/or the preamble, and may calculate at least one TA value related to at least one candidate cell based on the SRS and/or the preamble received from UE 801 in operation 816. After target DU 803 calculates the at least one TA value based on the SRS and/or the preamble, there may be following two options in different embodiments as below, i.e., Option X and Option Y.
(1) Option X: operations 817A and 818A are performed.
   a) In operation 817A, target DU 803 transmits the calculated TA value to CU 804 via F1 interface.
   b) In operation 818A, after receiving the at least one TA value from target DU 803, CU 804 transmits the at least one TA value and a cell ID of the at least one candidate cell (which is related to the at least one TA value) via an RRC message to UE 801 (e.g., through source DU 802). For example, multiple TA values and cell IDs of the corresponding multiple candidate cells can be carried in one single RRC message.
(2) Option Y: operations 817a, 817b, and 818b are performed.
   a) In operation 817A, target DU 803 transmits the calculated at least one TA value to CU 804, e.g., via F1 interface.
   b) In operation 817B, CU 804 transmits the at least one TA value and the cell ID of the at least one candidate cell to source DU 802, e.g., via F1 interface.
   c) In operation 818B, source DU 802 transmits the at least one TA value and a cell ID of the at least one candidate cell via DCI or MAC CE to UE 801. For example, multiple TA values and cell IDs of the corresponding multiple candidate cells can be carried in one single piece of DCI or in one single MAC CE.

In operation 819, UE 801 changes the serving cell and starts receiving or transmitting using the pre-configured UE-dedicated channel.

FIG. 9 illustrates a block diagram of an exemplary apparatus 900 in accordance with some embodiments of the present application. As shown in FIG. 9, the apparatus 900 may include at least one processor 906 and at least one transceiver 902 coupled to the processor 906. Although in this figure, elements such as the at least one transceiver 902 and processor 906 are described in the singular, the plural is contemplated unless a limitation to the singular is explicitly stated. In some embodiments of the subject application, the transceiver 902 may be divided into two devices, such as a receiving circuitry and a transmitting circuitry. In some embodiments of the subject application, the apparatus 900 may further include an input device, a memory, and/or other components.

In some embodiments of the subject application, the apparatus 900 may be a UE or a network node (e.g., a BS, a CU, or a DU). The transceiver 902 and the processor 906 may interact with each other so as to perform the operations with respect to the UE or the network node described above, for example, in any of FIGS. 1-8.

In some embodiments of the subject application, the apparatus 900 may further include at least one non-transitory computer-readable medium. For example, in some embodiments of the present disclosure, the non-transitory computer-readable medium may have stored thereon computer-executable instructions to cause the processor 906 to implement the method with respect to a UE or a network node (e.g., a BS, a CU, or a DU) as described above. For example, the computer-executable instructions, when executed, cause the processor 906 interacting with transceiver 902 to perform the operations with respect to the UE or the network node described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A user equipment (UE) for wireless communication, comprising:
at least one memory; and
at least one processor coupled with the at least one memory and configured to cause the UE to:
receive a radio resource control (RRC) reconfiguration message that includes first configuration information for one or more candidate cells;
get one or more timing advance (TA) values related to the one or more candidate cells by performing one or more random access (RA) procedures or by transmitting one or more reference signals to the one or more candidate cells; and
switch from a source cell to a first candidate cell within the one or more candidate cells, based at least in part on receiving a first indication associated with the first candidate cell from the source cell.

2. The UE of claim 1, wherein the RRC reconfiguration message includes at least one of a value of a first timer for RA for getting TA; or a maximum total number of preamble transmissions.

3. The UE of claim 2, wherein, after receiving the RRC reconfiguration message including the value of the first timer, the at least one processor is configured to cause the UE to start the first timer in response to initiating a first RA procedure for getting TA within the one or more RA procedures, wherein the first timer is associated with the first RA procedure.

4. The UE of claim 3, wherein the at least one processor is configured to cause the UE to:
stop the first timer, in response to successfully getting a TA value related to a candidate cell within the one or more candidate cells by performing the first RA procedure to the candidate cell; or
consider the first RA procedure as failed, in response to expiry of the first timer.

5. The UE of claim 2, wherein, after receiving the RRC reconfiguration message including the maximum total number of preamble transmissions, the at least one processor is configured to cause the UE to:
consider that a second RA procedure for getting TA within the one or more RA procedures is failed in response to reaching the maximum total number of preamble transmissions during the second RA procedure, wherein the maximum total number of preamble transmissions is associated with the second RA procedure.

6. The UE of claim 1, wherein, in response to failing to get the one or more TA values by performing the one or more RA procedures, the at least one processor UE is configured to cause the UE to one of:
transmit a first message to the source cell;
suspend the first configuration information for the one or more candidate cells; and
re-initiate the one or more RA procedures after a first time period.

7. The UE of claim 6, wherein the first message includes at least one of:
a second indication that the UE fails to get the one or more TA values related to the one or more candidate cells; or
a third indication that the one or more RA procedures are for getting the one or more TA values.

8. The UE of claim 1, wherein the first indication is included in a medium access control (MAC) control element (CE).

9. The UE of claim 1, wherein, in response to the first candidate cell being a primary secondary cell group cell (PSCell), the first indication is received by the UE from at least one of a secondary node (SN) or a master node (MN).

10. The UE of claim 1, wherein the at least one processor is configured to cause the UE to start a handover timer based at least in part on an RRC layer of the UE receiving the first indication from a lower layer of the UE.

11. The UE of claim 1, wherein the at least one processor is configured to cause the UE to:
determine whether a first TA value related to the first candidate cell is available or not, upon receiving the first indication;
in response to determining that the first TA value is unavailable, one of:
prohibit initiating a third RA procedure to the first candidate cell for getting TA based at least in part on determining that the first TA value is unavailable;
declare a RA failure;
determine whether elapsed time since the first TA value is considered as unavailable is less than or equal to a second time period, and prohibit initiating the third RA procedure in response to determining that the elapsed time is less than or equal to the second time period; and
initiate the third RA procedure upon determining that the first TA value is unavailable.

12. The UE of claim 11, wherein the at least one processor is configured to cause the UE to transmit failure related information to the first candidate cell in response to successfully getting the first TA value by performing the third RA procedure, and wherein the failure related information indicates that the first TA value is unavailable before initiating the third RA procedure.

13. The UE of claim 1, wherein the at least one processor is configured to cause the UE to perform a compliance check operation based on at least one of:
upon receiving the RRC reconfiguration message;
after receiving the RRC reconfiguration message and before initiating the one or more RA procedures;
after receiving the RRC reconfiguration message and before the UE being triggered to perform the one or more RA procedures;
upon initiating the one or more RA procedures; or upon the UE being triggered to perform the one or more RA procedures.

14. A centralized unit (CU), comprising:
at least one memory; and
a at least one processor coupled with the at least one memory and configured to cause the CU to:
transmit information to a user equipment (UE), wherein the information includes at least one of:
configuration information for one or more candidate cells;
at least one timing advance (TA) value related to at least one candidate cell within the one or more candidate cells; or
at least one identifier (ID) of the at least one candidate cell.

15. A target distributed unit (DU) for wireless communication, comprising:
at least one memory; and
at least one processor coupled with the at least one memory and configured to cause the DU to:
transmit information to a centralized unit (CU), wherein the information includes at least one of:
at least one timing advance (TA) value related to at least one candidate cell within one or more candidate cells of a user equipment (UE); or
at least one identifier (ID) of the at least one candidate cell.

16. The UE of claim 1, wherein the one or more reference signals include at least one of a preamble, or a sounding reference signal (SRS).

17. The UE of claim 1, wherein the at least one processor is configured to cause the UE to receive, from the source cell, a third message that includes at least one of:
at least one TA value related to at least one candidate cell within the one or more candidate cells; or
at least one identifier (ID) of the at least one candidate cell.

18. The UE of claim 17, wherein the third message is at least one of downlink control information (DCI), a medium access control (MAC) control element (CE), or an RRC message.

19. A method performed by a user equipment (UE), the method comprising:
receiving a radio resource control (RRC) reconfiguration message that includes first configuration information for one or more candidate cells;
getting one or more timing advance (TA) values related to the one or more candidate cells by performing one or more random access (RA) procedures or by transmitting one or more reference signals to the one or more candidate cells; and
switching from a source cell to a first candidate cell within the one or more candidate cells based at least in part on receiving a first indication associated with the first candidate cell from the source cell.

20. The method of claim 19, wherein the first indication is included in a medium access control (MAC) control element (CE).
